(19) United States
(12) Patent Application Publication
(10) Pub. No.: US 2016/0020962 A1
(43) Pub. Date: Jan. 21, 2016

(54) Management of Virtual CPES

(71) Applicant: Alcatel-Lucent USA Inc., Murray Hill, NJ (US)

(72) Inventors: Timothy Carey, Corpus Christi, TX (US); Ramesh Pattabhiraman, New Albany, OH (US)

(73) Assignee: Alcatel-Lucent USA Inc., Murray Hill, NJ (US)

(21) Appl. No.: 14/585,908

(22) Filed: Dec. 30, 2014

Related U.S. Application Data
(60) Provisional application No. 62/026,781, filed on Jul. 21, 2014.

(51) Int. Cl. H04L 12/24; H04L 29/08

(52) U.S. Cl. CPC H04L 41/5054; H04L 67/16

(57) ABSTRACT

A manner of managing remote devices in a communication system. In order to facilitate management of both traditional CPE (consumer premises equipment) devices and vCPEs (virtual CPEs), a vCPE is provided, preferable in communication with one or more VNF (virtual network function) managers and a vCPE descriptors file. When a management service operation is to be performed, at least one function associated with the management operation is identified and characterized. The management service operation may then be scheduled an executed by the appropriate end points according to the characterization.

### CROSS-REFERENCE TO RELATED APPLICATIONS

The present disclosure is related to and claims priority from U.S. Provisional Patent Application Ser. No. 62/026781, entitled Management of Virtual CPEs and filed on 21 Jul. 2014, the entire contents of which are incorporated by reference herein.

### TECHNICAL FIELD

The present invention relates generally to the field of communication networks, and, more particularly, to a method and apparatus for the remote management of CPEs (consumer premises equipment) and similar devices, especially vCPEs (virtual CPEs).

### BACKGROUND

The following abbreviations are herewith expanded, at least some of which are referred to within the following description of the state-of-the-art and the present invention.

AAA Authentication, Authorization, Accounting

ACS Auto Configuration Server

BRG Bridged Device function

CPE Customer Premises Equipment

CWMP CPE WAN Management Protocol

DM Device Management [Manager]

EMS Element Management System

NBI North Bound Interface

NE Network Element

NFV Network Function Virtualization

OSS/BSS Operations Support System/Business Support System

PCC Policy and Charging Control

SDN Software Defined Network

SMP [Motive®] Service Management Platform

SNMP Simple Network Management Protocol

SP Service Provider

SPR Subscriber Profile Respository

vG Virtual Gateway function

VIM Virtual Infrastructure Manager

VM Virtual Machine

VNF Virtual Network Function

VNFM Virtual Network Function Manager

Gateway devices (for example, CPEs) may include functions that are used to deliver services to the consumer by connecting computing or communicating equipment located on a customer premises (for example residential or enterprise business locations) with service provider and external networks.

These CPE functions may be installed according to a static configuration or, more advantageously, may be adjustable by the customer or an external device manager. User or on-site device management may be inefficient or unreliable, so that latter is generally preferred. To ensure proper remote management of various gateway devices, standard protocols have been developed, for example TR-069 promulgated by the Broadband Forum.

In the future, the functions of many CPEs may be moved from the customer premises to the service provider's network where the function may also be hosted in a virtualized execution environment. That is, instead of having all of the gateway functions performed by actual CPE, many functions may be executed elsewhere. It remains an advantage to be able to remotely manage these gateway functions wherever the functions are installed. Virtual CPE management using existing device management solutions, however, may not be as effective or efficient, if it can be done at all.

Note that the techniques or schemes described herein as existing or possible are presented as background for the present invention, but no admission is made thereby that these techniques and schemes were heretofore commercialized or known to others besides the inventors.

### SUMMARY

In various embodiments, inventors propose a vCPE orchestrator and a method for managing vCPEs. The vCPE orchestrator may but does not necessarily reside in a service provider network. The vCPE orchestrator may be implemented in hardware or in software stored in tangible media for execution in one or more processing devices. These processing devices may or may not be centrally located.

The vCPE orchestrator includes or is in communication with a mapping database on a memory device that includes relationships virtual and non-virtual functional instances wherever they are located (for example, in the customer premises or the service provider network). Unless recited otherwise in a particular embodiment, the memory device includes a physical memory and is non-transitory in the sense of not being merely a propagating signal.

In operation, the vCPE orchestrator determines that a particular service operation is to be performed. This determination may be but is not necessarily determined by a direction received from the OSS/BSS associated with a particular network. Upon making the determination, the vCPE orchestrator directs the execution of the service operation. In a preferred embodiment, the vCPE orchestrator includes a decision engine that determines the management action or actions required to fulfill the service operation and the interfaces that are to be utilized for performing the management actions.

In this preferred embodiment, the decision engine determines that function or functions that are to be affected by the service operation, and for each such function determines whether the function is shared or unshared. A determine is also made was to whether a function is virtualized or unvirtualized and where the function is located. Note that functions located at a customer premises may in some embodiments simply be presumed to be subscriber specific (that is, unshared). These determinations may be made by reference to a mapping database.

In this preferred embodiment, the vCPE orchestrator schedules the management actions and opens the necessary (or desired) interfaces. The management actions may then be performed according to the schedule.

Note that the sequence of operations described above may in other embodiments be performed in any logically-consistent order. In some implementations, there may be additional operations performed as well, and in some cases, fewer.

The proposed solution may be implemented as computer program instructions stored on a memory device that when executed on one or more processors perform the operations involved in a particular embodiment.

Additional aspects of the invention will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

A more complete understanding of the present invention may be obtained by reference to the following detailed description when taken in conjunction with the accompanying drawings wherein:

FIG. 1 is a functional block diagram illustrating a management system 100 according to an embodiment of the present invention; and

FIG. 2 is a flow diagram illustrating a method 200 of managing remote devices in a communication network according to an embodiment of the present invention.

### DETAILED DESCRIPTION

Disclosed herein is a manner of remotely managing CPE (customer premises equipment) and similar devices. Remote management permits a service provider to manage devices typically located at the home or business of a subscriber without a site visit or relying on the customer to perform the management functions themselves. The solution presented here facilitates remote management of virtual CPEs.

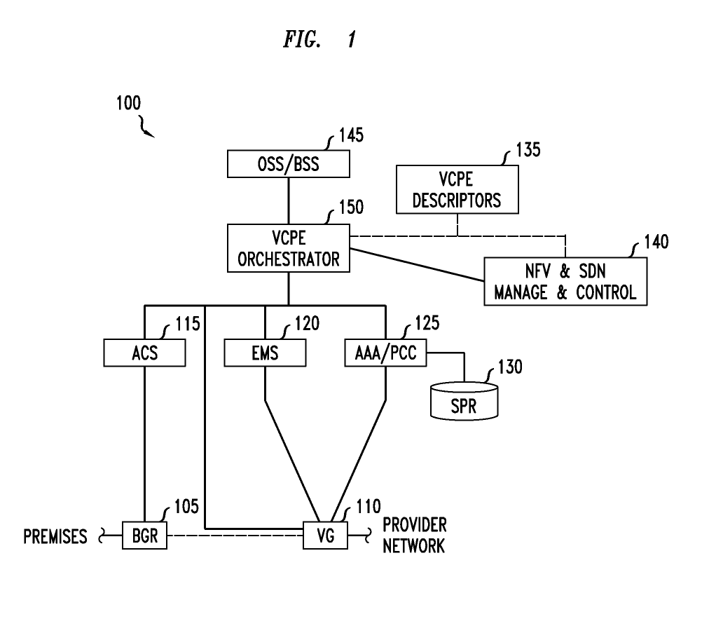

FIG. 1 is a functional block diagram illustrating a management system 100 according to an embodiment of the present invention. In this embodiment, BRG (bridge or bridging function) 105 is located at a customer premises and present in a device located there. BRG 105 may in turn be in communication with one or more customer devices located with the premises. This may represent the physical connection between the provider network and a customer network, either a home network or a business enterprise.

The vG (virtual gateway) 110, on the other hand, while performing many of the functions of a traditional residential or enterprise gateway device, may be located anywhere, for example in the provider network. The management of BRG 105 and vG 110 are in this embodiment performed by management system 100.

In this embodiment, management system 100 also includes an ACS (auto configuration server) 115. The ACS 115 typically performs management of TR-069 (Broadband Forum technical report-069) end points such as BRG 105. EMS (element management system) 120 may manage, for example, supporting vG functions or vG functions that are co-located with an NE (network element). AAA/PCC 125 controls QoS and charging in a vCPE in association with the SPR (subscriber profile repository) 130.

In accordance with this embodiment, system 100 also includes a vCPE orchestrator 150. vCPE orchestrator performs, for example, on-boarding and lifecycle management of vCPE services, management of the instantiation of vNFs (virtual network functions) in cooperation with the vNFMs (vNF managers) of NFV (network function virtualization) & SDN (software defined network) control 140. In this embodiment, vCPE orchestrator also performs the provisioning of vNFs that constitute a vCPE, alarm correlation and trouble-shooting of vCPEs, and management of the integrity and visibility of vCPE instances.

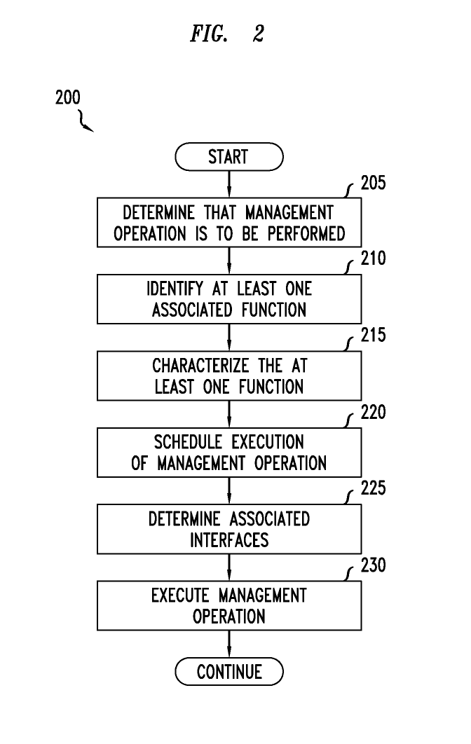

In addition to one or more vNF managers, NFV & SDN management and control 140 in this embodiment also includes an NFV manager and VIM (virtualization infrastructure manager), as well as the SDN control function itself (not separately shown). An operation of vCPE orchestrator 150 in cooperation with NFV & SDN management and control 140 is described below in reference to FIG. 2. In performing vCPE management, vCPE orchestrator 150 and NFV & SDN management and control 140 utilize vCPE descriptor files 135, which describe the vCPE deployment model or models, for example network functions, connections, roles, and so forth.

In this embodiment, management system 100 also includes an OSS/BSS 145, which may handle, for example, customer portal and call center interfaces, order management and billing, and subscriber-line activation and management.

In this embodiment, management system 100 also includes at least one processor and a memory device (not separately shown. The at least one processor is implemented in hardware or through software program instructions executing on a hardware device. The memory device in this embodiment is a physical storage device that may in some cases operate according to stored program instructions. In any case, the memory is non-transitory in the sense of not being merely a propagating signal. The memory is used for storing, among other things, vCPE descriptor files relating to managed devices as well as stored program instructions for execution by the at least one processor and possibly other components of management system 100.

Described above in reference to FIG. 1 are selected components of an embodiment, and some variations are also described above. Other variations are possible without departing from the claims of the invention as there recited. In some of these embodiments, illustrated components may be integrated with each other or divided into subcomponents. There will often be additional components in the management system 100 and in some cases fewer components. The illustrations components may also perform other functions in addition to those described above.

FIG. 2 is a flow diagram illustrating a method 200 of managing remote devices in a communication network according to an embodiment of the present invention. At Start it is presumed that the necessary components for executing method 200 according to this embodiment are present and operational. The process then begins with determining (step 205), for example by the vCPE orchestrator 150 illustrated in FIG. 1, that a management service operation is to be performed. At least one BRG or vG function associated with the execution of the management operation is identified (step 210).

In accordance with this embodiment, the at least one function is then characterized (step 215). The characterization may include, for example, determining whether the function is a shared or unshared function. Generally speaking, an unshared function is one that is subscriber-specific. A shared function, on the other hand, has managed entities that perform a network function incorporating sub-functions that are subscriber specific.

The characterization of step 215 may also include determining whether the at least one function is virtualized or non-virtualized as well as determining a location for the at least one function, that is, whether it is a network function or a premises function.

In the embodiment of FIG. 2, the method 200 may also include scheduling (step 220) of the management operation, and determining (step 225) the interfaces associated with the management operation. In this embodiment, each BRG or vG functional instance is mapped to one or more end points. An end point is a management agent having management responsibility for the respective BRG or vG, although a given end point may have to be orchestrated across multiple BRG or functional instances.

In a preferred embodiment, end point mapping is implemented in the vCPE orchestrator. End point information that may be required includes location and the appropriate interface, as well as knowledge of the associated messaging.

In the embodiment of FIG. 2, the management service operation may then be executed (step 230) using the appropriate interface or interfaces in accordance with the characterization. The process then continues with execution of other required management operations, if any.

In this manner the solutions proposed herein recognize the multi-dimensional nature of the location and environment of management service operations, and facilitate managing both traditional CPE devices and vCPEs in multiple domains.

Note that the sequence of operation illustrated in FIG. 2 represents an exemplary embodiment; some variation is possible within the spirit of the invention. For example, additional operations may be added to those shown in FIG. 2, and in some implementations one or more of the illustrated operations may be omitted. In addition, the operations of the method may be performed in any logically-consistent order unless a definite sequence is recited in a particular embodiment.

Although multiple embodiments of the present invention have been illustrated in the accompanying Drawings and described in the foregoing Detailed Description, it should be understood that the present invention is not limited to the disclosed embodiments, but is capable of numerous rearrangements, modifications and substitutions without departing from the invention as set forth and defined by the following claims.

1. A method of managing remote devices in a communication network, comprising:
determining that a management operation is to be performed;
identifying at least one function that is associated with the management operation; and
characterizing the at least one function.

2. The method of claim 1, further comprising scheduling execution of the management operation.

3. The method of claim 2, further comprising determining the interfaces associated with the management operation.

4. The method of claim 3, further comprising executing the management operation based on the characterization.

5. The method of claim 1, wherein characterizing the at least one function comprises:
determining whether the at least one function is a shared function;
determining whether the at least one function is a virtualized function; and
determining the location of the at least one function.

6. A system for managing remote devices in a communication network, comprising a vCPE orchestrator.

7. The system of claim 6, further comprising a vCPE descriptor table accessible to the vCPE orchestrator.

8. The system of claim 7, further comprising at least one ACS (auto configuration server).

9. The system of claim 8, wherein the vCPE is resident on the ACS.
